(19) United States
(12) Patent Application Publication
(10) Pub. No.: US 2023/0136091 A1
(43) Pub. Date: May 4, 2023

(54) HIGH-PERFORMANCE STORAGE INFRASTRUCTURE OFFLOAD

(71) Applicant: Intel Corporation, Santa Clara, CA (US)

(72) Inventors: Kapil Karkra, Chandler, AZ (US); Filip Schmole, Portland, OR (US); Pankaj Kumar, Fremont, CA (US)

(21) Appl. No.: 18/148,478

(22) Filed: Dec. 30, 2022

(51) Int. Cl. G06F 9/46

(52) U.S. Cl. CPC G06F 9/467

(57) ABSTRACT

Technology described herein provides an improved system architecture for offloading infrastructure tasks using a multi-root switch with logic to route, via a switch, application data in a data transfer message between a physical storage device and a host system, the host system interfacing with a virtual function of an IPU, by remapping a transaction identifier field in the data transfer message between a first transaction identifier associated with the virtual function and a second transaction identifier associated with the physical storage device, where the physical storage device is managed by the IPU, and where to route the application data between the host system and the physical storage device includes to bypass temporary storage of the application data in a memory local to the IPU. In some examples a remapping table holds the first transaction identifier and the second transaction identifier.

### TECHNICAL FIELD

Embodiments generally relate to computing systems. More particularly, embodiments relate to cloud-based systems using an infrastructure processing unit architecture with high performance offload.

### BACKGROUND

Some existing cloud-based systems (e.g., data centers) use an infrastructure processing unit (IPU) to handle certain tasks relating to management/control of the cloud (e.g., data center) infrastructure, instead of such tasks being performed by a host central processing unit (CPU). Such offloading of infrastructure tasks to the IPU frees the host CPU to handle more tasks requested by remote clients and/or to handle client-requested tasks more quickly and efficiently. Existing IPU-based implementations, however, present data traffic bottlenecks and are restricted in the number of storage drives that can be supported, all of which limits system performance and scalability.

### BRIEF DESCRIPTION OF THE DRAWINGS

The various advantages of the embodiments will become apparent to one skilled in the art by reading the following specification and appended claims, and by referencing the following drawings, in which:

FIGS. 1A-1C provide diagrams illustrating a cloud-based system architecture used in existing designs;

FIGS. 2A-2C provide diagrams illustrating an example of a cloud-based system architecture according to one or more embodiments;

FIGS. 3A-3B provide diagrams illustrating examples of command flow sequences for application data in a cloud-based system according to one or more embodiments;

FIGS. 4A-4B provide diagrams illustrating an example of a multi-root switch with remapping module according to one or more embodiments;

FIGS. 5A-5C provide flow diagrams illustrating an example application data transfer method according to one or more embodiments;

FIG. 6 is a block diagram of an example of a performance-enhanced computing system according to one or more embodiments; and

FIG. 7 is a block diagram illustrating an example semiconductor apparatus according to one or more embodiments.

### DESCRIPTION OF EMBODIMENTS

A performance-enhanced computing system as described herein provides an improved system architecture with an IPU for offloading infrastructure tasks. The improved system architecture uses a multi-root switch to route application data between host processor memory and cloud storage, which provides additional bandwidth and connectivity to storage devices. By using transaction identifier substitution (remapping), the technology provides for bypassing temporary storage of the application data in local IPU memory, permitting direct transfer of data between host memory and cloud storage devices. The technology helps improve the overall performance of cloud-based systems by increasing data storage throughput, eliminating critical data bottlenecks, and enabling an increase in the number of storage drives controlled by the architecture.

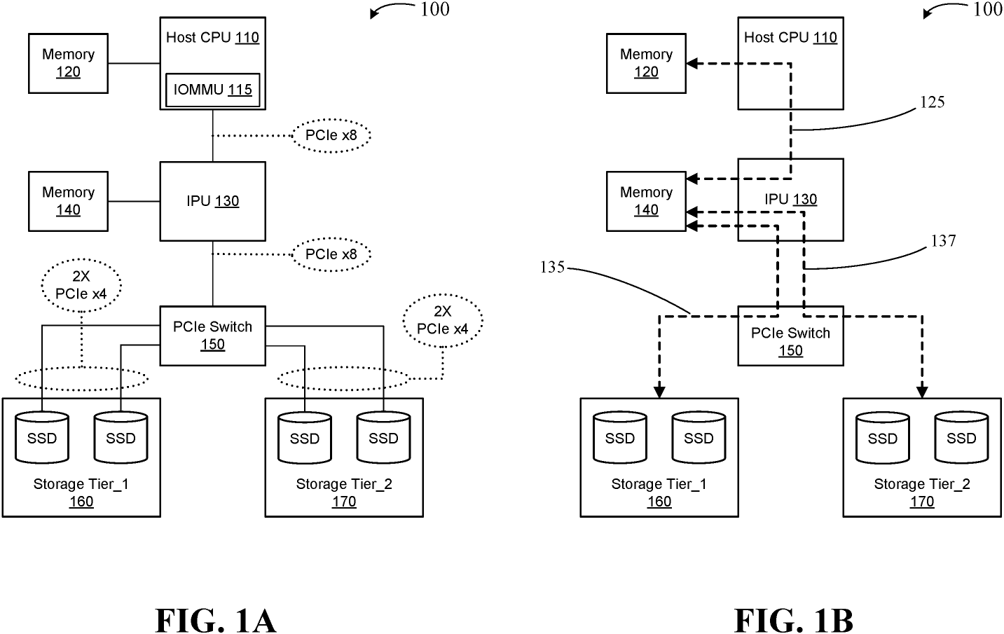

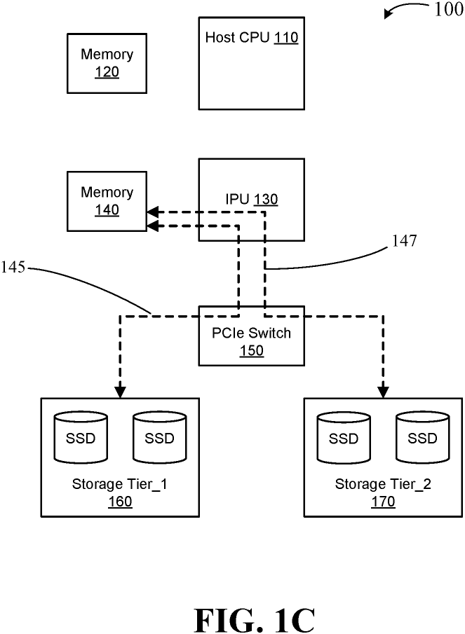

FIG. 1A provides a block diagram illustrating a cloud-based system architecture 100 as used in existing designs. The system architecture 100 includes a host CPU 110, an IPU 130, a PCIe switch 150, a first storage tier 160 and a second storage tier 170. The host CPU can include, e.g., an Intel® Xeon® CPU. The host CPU 110 includes an input/output memory management unit (IOMMU) 115 to monitor data traffic between the host CPU 110 and other architecture devices, such as the IPU 130. The host CPU 110 has a host local memory 120 used by the host CPU 110 — e.g., for executing applications. The host CPU 110 and the host local memory 120 form a host system (or at least a portion thereof). The host local memory 120 can include, e.g., dynamic random access memory (DRAM). For example, the IOMMU 115 performs verification and address translation for commands and data packets between the host CPU 110 (and including the host local memory 120) and other architecture devices. For example, the IOMMU 115 verifies that a requesting source (e.g., a virtual SSD via the IPU 130) is authorized to access a local memory block (e.g., in the host local memory 120) for data reads or writes.

The IPU 130 provides infrastructure support and services to the host CPU 110 including, for example, networking and security services as well as managing data storage in the first storage tier 160 and the second storage tier 170. The IPU 130 can include, e.g., an Intel® Mt. Evans IPU. The IPU 130 has IPU local memory 140 used by the IPU 130 - e.g., for storing data, submission/completion queues, etc. The IPU local memory 140 can include, e.g., DRAM. The IPU 130 exposes to the host CPU 110 a set of PCIe endpoints - e.g., single root I/O virtualization (SR-IOV) virtual functions. The PCIe endpoints expose nonvolatile memory express (NVMe) virtual interfaces - e.g., submission/completion queues, which accept NVMe commands and return NVMe responses. NVMe is a storage access and transport protocol used for solid state drives (SSDs), e.g., flash memory drives. The IPU 130 also runs a host-based flash translation layer (FTL) to manage SSD operations such as, e.g., logical-to-physical address translation, garbage collection, wear-leveling, etc. Through FTL the IPU 130 provides virtual SSDs for use by the host CPU 110.

The IPU 130 has a total of 16 peripheral component interconnect express (PCIe) lanes. The IPU 130 is coupled to the host CPU 110 via eight of the PCIe lanes, and the IPU 130 is coupled to the PCIe switch 150 (a single-root switch) via the remaining eight PCIe lanes. The IPU 130 interfaces with SSDs in the first storage tier 160 and SSDs in the second storage tier 170 via the PCIe switch 150. The PCIe switch 150 is coupled to the SSDs in the first storage tier 160 via a set of eight PCIe lanes, where each solid state drive (SSD) in the first storage tier 160 occupies four PCIe lanes. Similarly, the PCIe switch 150 is coupled to the SSDs in the second storage tier 170 via a set of eight PCIe lanes, where each SSD in the second storage tier 170 occupies four PCIe lanes.

The first storage tier 160 and the second storage tier 170 each include two physical SSDs (physical devices) for data storage. Based on the system architecture 100, the first storage tier 160 and the second storage tier 170 are limited to two SSDs, for example because the PCIe switch 150 only has eight PCIe lanes each for coupling to the first storage tier 160 and the second storage tier 170, respectively, and each SSD occupies four of the PCIe lanes. The system architecture 100 is effectively limited to an eight-lane PCIe switch because the IPU 130 only has eight (of its total 16 PCIe lanes) available for coupling to the PCIe switch 150; the other eight lanes for the IPU 130 are coupled to the host CPU 110. The first storage tier 160 can, for example, be a “cache” tier (e.g., used for “hot” data/objects), and the SSDs in the first storage tier 160 can include, e.g., Intel® Optane™ memory devices. The second storage tier 170 can, for example, be a “capacity” tier (e.g., used for “cold” data/objects), and the SSDs in the second storage tier 170 can include, e.g., quad-level cell (QLC) flash memory devices.

The host CPU 110 does not directly communicate with the SSDs in the first storage tier 160 or in the second storage tier 170. Indeed, the host CPU 110 does not even know the identity/location of the physical SSDs (e.g., the SSDs are hidden from the host CPU 110). Instead, the IPU 130 provides virtual SSDs to the host CPU 110 via FTL using NVMe commands/interfaces. The IPU 130 effectively converts host read/write requests for virtual SSDs into requests having physical addressing for the SSDs in the first storage tier 160 or in the second storage tier 170.

In operation, the IPU 130 exposes PCIe virtual functions (VFs) that the FTL uses to expose virtual NVMe volumes (virtual SSDs) to the host CPU 110 through the virtual NVMe interfaces. These virtual NVMe volumes can be direct assigned to the virtual machines (VMs) running on the host CPU 110. The FTL stores its persistent metadata (e.g., logical to physical (L2P) address mapping table) on an SSD partition. For example, FTL metadata is stored on an SSD in the first storage tier 160, while the remaining capacity of the first storage tier 160 is used as a cache tier to place hot/temp data.

The IPU 130 maintains NVMe I/O submission queue(s) and NVMe I/O completion queue(s). NVMe commands (I/O) are placed into a submission queue, and completions (e.g., for the commands) are placed in an associated completion queue. Multiple submission queues can be associated with the same completion queue. The IPU 130 also maintains NVMe administration queue(s) for device management and control - e.g., creation and deletion of I/O Submission and Completion Queues, etc.

FIG. 1B provides a diagram illustrating application data flows in the system architecture 100, which implements a store-and-forward scheme. When the host CPU 110 is running an application, the host CPU 110 can initiate data transfer requests for transferring application data between the host (e.g., between the host local memory 120 attached to the host CPU 110) and a virtual SSD (e.g. via a VF as presented by the IPU 130 to the host CPU 110). For example, when the host CPU 110 requests a transfer of application data from the host local memory 120 to a VF/virtual SSD, the IPU 130 causes the requested application data to be retrieved from the host local memory 120 and temporarily stored in the IPU local memory 140, thus the flow of data follows a data path 125. The IPU 130 then causes the application data to be moved from temporary storage in the IPU local memory 140 to a physical location in one of the SSDs (the target SSD). For example, if the IPU 130 causes the application data to be transferred to a target SSD in the first storage tier 160, the flow of data follows a data path 135 between the IPU local memory 140 and the target SSD in the first storage tier 160. As another example, if the IPU 130 causes the application data to be transferred to a target SSD in the second storage tier 170, the flow of data follows a data path 137 between the IPU local memory 140 and the target SSD in the second storage tier 170.

Similarly, as another example, when the host CPU 110 requests a transfer of application data from a VF/virtual SSD to the host local memory 120, the IPU 130 causes the requested application data to be retrieved from a physical location in one of the SSDs (the target SSD) and temporarily stored in the IPU local memory 140. For example, if the IPU 130 causes the application data to be transferred from a target SSD in the first storage tier 160, the flow of data follows the data path 135 between the target SSD in the first storage tier 160 and the IPU local memory 140. As another example, if the IPU 130 causes the application data to be transferred from a target SSD in the second storage tier 170, the flow of data follows the data path 137 between the target SSD in the second storage tier 170 and the IPU local memory 140. The IPU 130 then causes the application data to be moved from temporary storage in the IPU local memory 140 to the host local memory 120, where the flow of data follows the data path 125.

FIG. 1C provides a diagram illustrating data compaction and garbage collection flows in the system architecture 100. Data compaction (e.g., FTL compaction) involves transferring stored data between the first storage tier 160 (e.g., a “cache” tier) and the second storage tier 170 (e.g., a capacity” tier), and is conducted under the control of the IPU 130. For example, the IPU 130 can, as part of the FTL compaction process, read and merge valid data from SSD(s) in the first storage tier 160 to SSD(s) in the second storage tier 170 sequentially using, e.g., large-sized writes. For example, data stored in the first storage tier 160 may become “cold” (e.g., objects that have been reassigned from a hot tier to a cold tier) and, thus, is transferred to the second storage tier 170. To carry out this data transfer, the IPU 130 causes the subject stored data to be retrieved from an SSD in the first storage tier 160 and temporarily stored in the IPU local memory 140, with the data flow following the data path 145. The IPU then causes the subject data to be moved from temporary storage in the IPU local memory 140 to a target SSD in the second storage tier 170, with the data flow following the data path 147.

Similarly, as another example, data stored in the second storage tier 170 may, as a result of an application, become “hot” (e.g., objects that have been reassigned from a cold tier to a hot tier) and, thus, is transferred to the first storage tier 160. To carry out this data transfer, the IPU 130 causes the subject stored data to be retrieved from an SSD in the second storage tier 170 and temporarily stored in the IPU local memory 140, with the data flow following the data path 147. The IPU then causes the subject data to be moved from temporary storage in the IPU local memory 140 to a target SSD in the first storage tier 160, with the data flow following the data path 145.

Garbage collection (e.g., FTL garbage collection) involves, at a high level, moving good data to new pages or blocks and erasing blocks with old data to provide new storage, and is conducted under the control of the IPU 130. As an example, to perform garbage collection on a target SSD in the second storage tier 170, the IPU 130 causes valid data in a used block on the target drive to be retrieved from the target drive and temporarily stored in the IPU local memory 140. The IPU 130 then causes this valid data to be moved to a new block on the target drive, and the used block on the target drive is erased. Thus the garbage collection causes data transfers that follow the data path 147 between the second storage tier 170 and the IPU local memory 140.

As a result of the store-and-forward scheme used in the system architecture 100, all of the data transfers between the IPU 130 and the memory storage tiers (i.e., the first storage tier 160 and/or the second storage tier 170) - e.g., data transfers resulting from application execution as well as data compaction and garbage collection - utilize the eight PCIe lanes between the IPU 130 and the PCIe switch 150. This results in a critical data bottleneck in those eight PCIe lanes. For example, a typical PCIe bandwidth demand generated by application reads and writes to a single hot/cold drive pair (e.g., one SSD in the first storage tier 160 and one SSD in the second storage tier 170) is on the order of 8 GB/s.

Further, the FTL compaction process, in the worst case, reads all of the application data from SSDs in the first storage tier 160 and writes the data to SSDs in the second storage tier 170, thus generating two times 8 GB/s (i.e., 16 GB/s) of additional bandwidth demand. Assuming a nominal FTL write amplification factor for big data workloads, the FTL garbage collection process further generates on the order of 10 GB/s bandwidth demand (of note, that this bandwidth demand is much higher for random workloads). Thus, there is a potential bandwidth demand of 34 GB/s through the critical bottleneck (the eight PCIe lanes) between the IPU 130 and the PCIe switch 150. Thus, at worst case, the eight available PCIe lanes in the IPU 130 cannot sustain the bandwidth demand of even a single SSD pair. Even if the FTL compaction and garbage collection did not burden the critical bottleneck, application read/write demands cannot scale beyond the current two drive per tier architecture.

Furthermore, as described above, a transfer of application data between the host local memory 120 and a storage tier (e.g., the first storage tier 160 or the second storage tier 170 ) results in two application data transfers: one transfer between the host local memory 120 and the IPU local memory 140, and another transfer between the IPU local memory 140 and a physical SSD in the respective storage tier. Such duplication of data transfers caused by the store-and-forward scheme results in delays and inefficiencies in application execution. Moreover, the store-and-forward scheme requires IPU implementations to provision for sufficient local DRAM bandwidth as well as sufficient compute resources (e.g., a number of CPU cores on the IPU), providing further disadvantages, especially given power constraints.

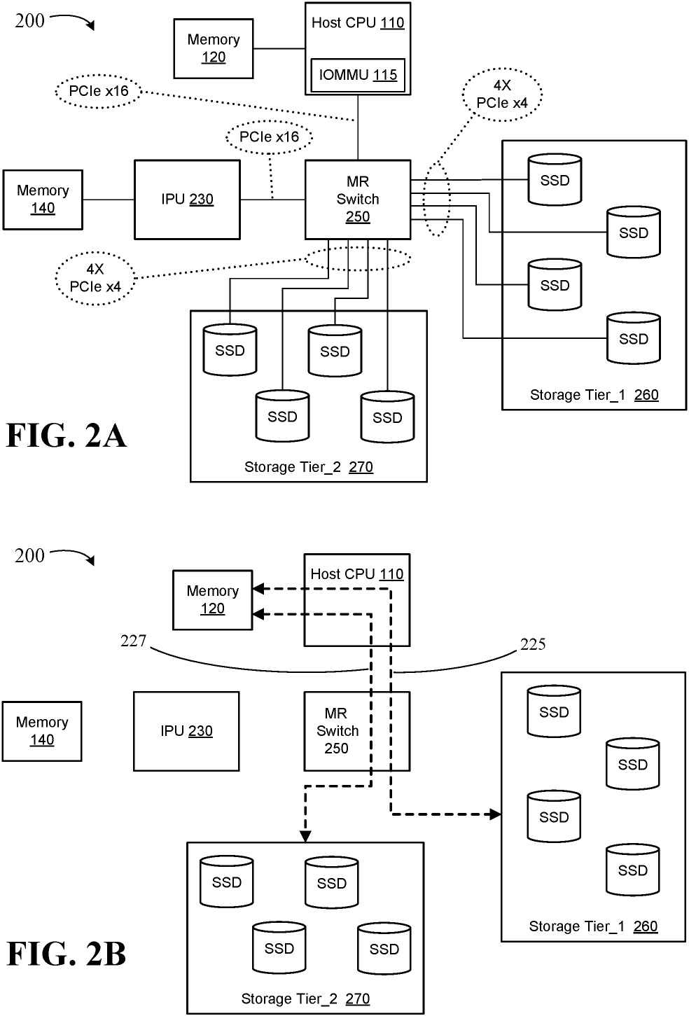

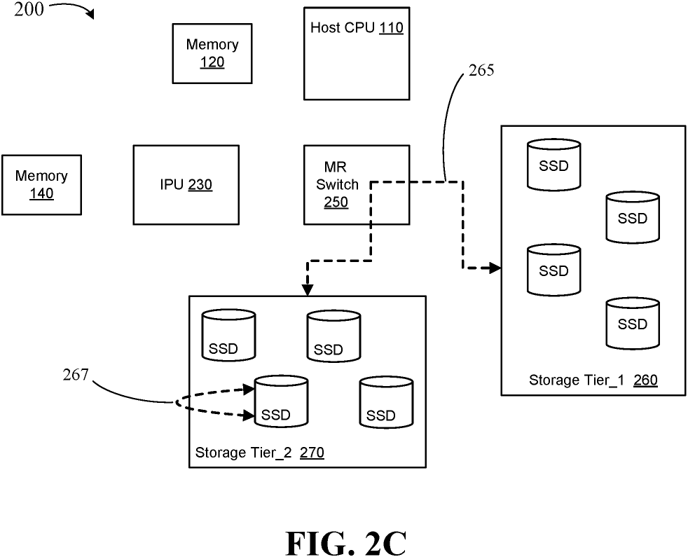

FIG. 2A provides a block diagram illustrating an example of an improved cloud-based system architecture 200 according to one or more embodiments, with reference to components and features described herein including but not limited to the figures and associated description. The system architecture 200 includes some components and features that are the same as or similar to those in the system architecture 100 (FIGS. 1A-1C, already discussed), and those components and features will not be repeated except as necessary to describe the new / additional components and features of the system architecture 200. As shown in FIG. 2A, the system architecture 200 includes a host CPU 110, an IPU 230, a multi-root (MR) switch 250, a first storage tier 260 and a second storage tier 270. In embodiments the MR switch 250 is a 64-lane multi-root PCIe switch. The host CPU 110 is coupled to the MR switch 250 (which is a PCIe-compatible switch) via 16 PCIe lanes, and interfaces with the other devices (e.g., the IPU 230, SSDs in the first storage tier 260 and/or SSDs in the second storage tier 270) through the MR switch 250 as described herein. For example, commands/messages between the host CPU 110 and the IPU 230 are routed through the MR switch 250.

The IPU 230 includes the same or similar functionality as the IPU 130, and can include, e.g., an Intel® Mt. Evans IPU. The IPU 230 - similar to the IPU 130 - has a total of 16 PCIe lanes, all of which are used to couple the IPU 230 to the MR switch 250. In other words, unlike the system architecture 100, where the 16 PCIe lanes of the IPU 130 are split between coupling to the host CPU 110 (via eight PCIe lanes) and coupling to the PCIe switch 150 (via the remaining eight PCIe lanes), in the system architecture 200 the IPU 230 does not need to split the 16 PCIe lanes between coupling to the host CPU 110 and coupling to the MR switch 250. The IPU 230 interfaces with the other devices (e.g., the host CPU 110, SSDs in the first storage tier 260 and/or SSDs in the second storage tier 270) through the MR switch 250. The IPU 230 is used primarily for handling the control path for controlling how the data moves in the system architecture 200. The IPU 230 also runs a flash translation layer (FTL) which has been offloaded from the host CPU 110 - thus saving processing cycles for the host CPU 110. FTL metadata is stored on an SSD in the first storage tier 260. As described herein, the system architecture 200 avoids the store-and-forward scheme of existing designs and instead employs direct data movement between the host local memory 120 and the memory storage tiers (e.g., the first storage tier 260 and/or the second storage tier 270) via the MR switch 250.

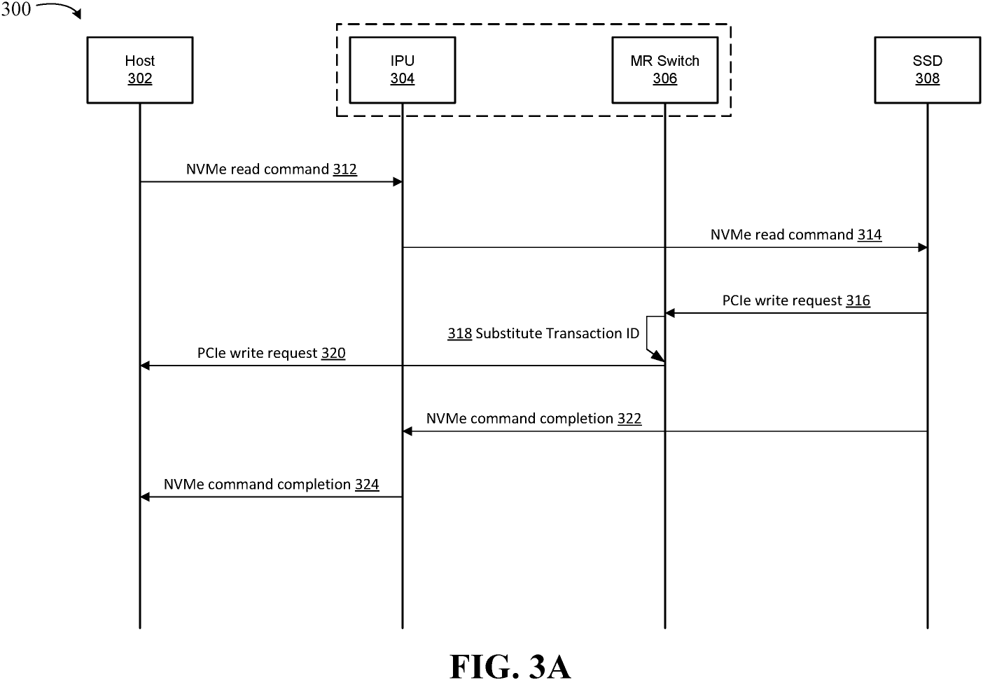

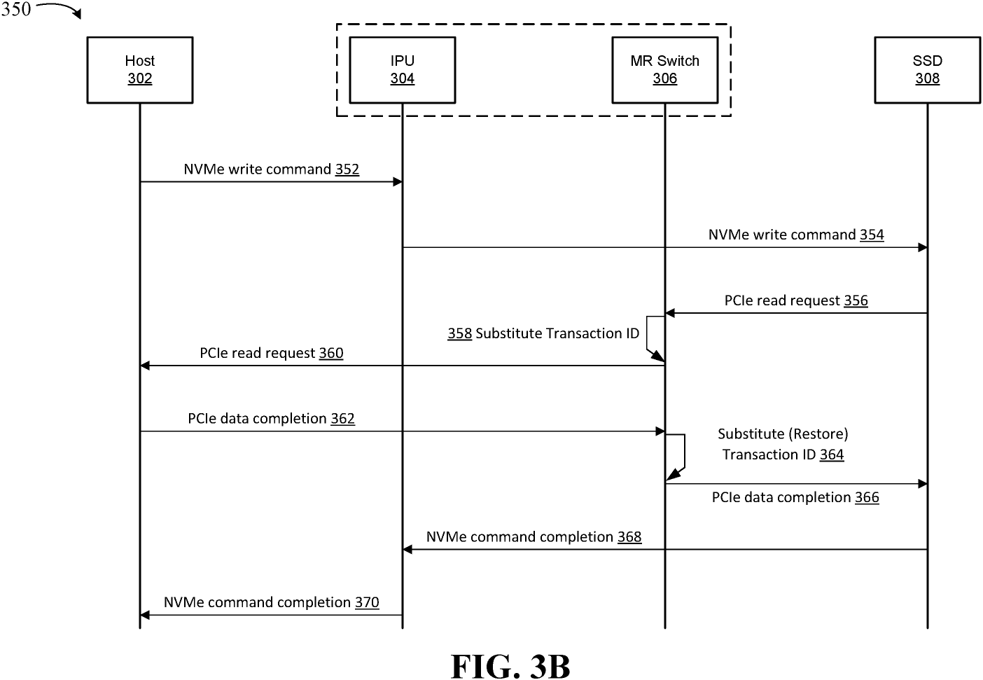

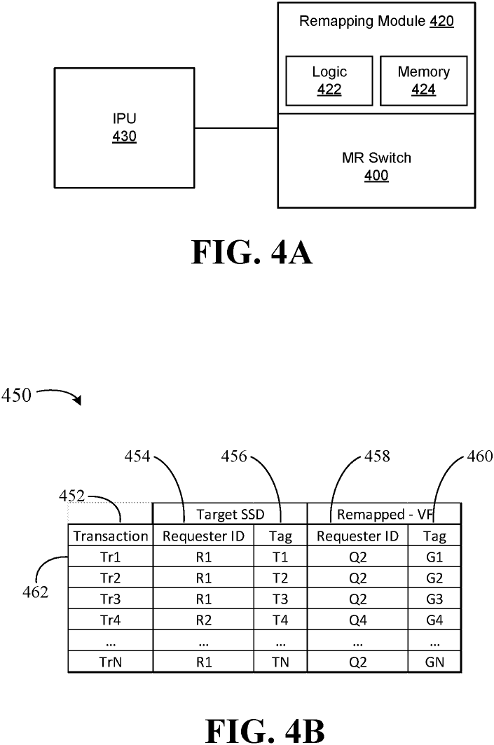

The MR switch 250 is coupled to four SSDs in the first storage tier 260 via a set of 16 PCIe lanes, where each SSD in the first storage tier 260 occupies four PCIe lanes. Similarly, the MR switch 250 is coupled to four SSDs in the second storage tier 270 via a set of 16 PCIe lanes, where each SSD in the second storage tier 270 occupies four PCIe lanes. The downstream switch ports coupling to the SSDs in the storage tiers 260 and 270 are assigned to a root port (RP) of the IPU 230 (and are hidden from the host CPU 110). As further described herein with reference to FIGS. 3A-3B and 4A-4B, the MR switch 250 includes (or is otherwise coupled to) a remapping module to perform transaction identifier (ID) remapping (including, e.g., transaction ID substitution and/or restoration) that enables the direct data movement between the host local memory 120 and the first storage tier 260 and/or the second storage tier 270.

The first storage tier 260 and the second storage tier 270 each include four physical SSDs (physical devices) for data storage. Based on the system architecture 200, the first storage tier 260 and the second storage tier 270 can each accommodate four SSDs, because the MR switch 250 has 16 PCIe lanes each for coupling to the first storage tier 260 and the second storage tier 270, respectively, and each SSD occupies four of the PCIe lanes. The first storage tier 260 can, for example, be a “cache” tier (e.g., used for “hot” data/objects), and the SSDs in the first storage tier 260 can include, e.g., Intel® Optane™ memory devices. The second storage tier 270 can, for example, be a “capacity” tier (e.g., used for “cold” data/objects), and the SSDs in the second storage tier 270 can include, e.g., quad-level cell (QLC) flash memory devices. FTL metadata is stored on an SSD in the first storage tier 260, while the remaining capacity of the first storage tier 260 is used as a cache tier to place hot/temp data.

The view of this architecture from the perspective of the host CPU 110 is simply an SR-IOV capable IPU 230. The host CPU 110 does not know the identity/location of the physical SSDs (the SSDs are hidden from the host CPU 110). Instead, the IPU 230 provides virtual SSDs to the host CPU 110 via FTL using NVMe commands/interfaces. The IPU 230 effectively converts host read/write requests for virtual SSDs into requests having physical addressing for the SSDs in the first storage tier 260 or in the second storage tier 270. The IPU 230 can use a private PCIe fabric via the MR switch 250 to manage the physical SSDs.

In operation, the IPU 230 exposes PCIe virtual functions (VFs) that the FTL uses to expose virtual NVMe volumes (virtual SSDs) to the host CPU 110 through the virtual NVMe interfaces. These virtual NVMe volumes can be direct assigned to the virtual machines (VMs) running on the host CPU 110. The host CPU 110 enumerates these VFs, discovers virtual NVMe controllers, and then binds NVMe drivers to them. The host CPU 110 neither “sees” nor enumerates the physical NVMe SSDs (they are hidden by the MR switch 250). Only the IPU can enumerate the physical NVMe SSDs.

As described further herein with reference to FIGS. 3A-3B and 4A-4B, the remapping module (e.g., in the MR switch 250) performs transaction ID remapping that enables the direct data movement between the host local memory 120 and the first storage tier 260 and/or the second storage tier 270. The MR switch 250 makes it appear to the host CPU 110 as if requests to the host CPU 110 from the physical SSDs are from the VFs. It accomplishes this using a requester ID/completer ID substitution (remapping) scheme. The remapping scheme involves a single table remapping of IPU space IDs to host space IDs. For any transfers between physical SSDs and the host CPU 110, the MR switch 250 replaces the requester ID of the physical SSD with that of the matching table entry (e.g., corresponding to a virtual SSD relating to a VF). The MR switch 250 must perform this substitution in both directions - that is, substituting (e.g., restoring) the original requester ID for completions that the host CPU 110 returns to the IPU / virtual SSD. The IPU 230 configures the ID remapping table (which is stored in memory in the MR switch 250 and described further herein with reference to FIGS. 4A-4B).

The remapping table stored in the memory of the MR switch 250 also includes, in embodiments, transaction tags to enable retagging, by the MR switch 250, of requests from both the IPU 230 and the physical SSDs. Retagging is implemented to disambiguate the routing of completions from the host CPU 110 targeting the IPU’s VF requester ID (e.g., virtual SSD ID), which may have originated either from IPU 230 or one of the physical SSDs. The MR switch 250 must store the transaction ID (requester ID plus tag) of the original request and substitute it with the transaction ID of the VF. Subsequently, when the host CPU 110 returns a data transfer completion, the MR switch 250 must substitute (e.g., restore) the transaction ID of the original request.

In embodiments, the IPU 230 also provides a base address register (BAR) that maps the entire range of the IPU local memory 140 into the host address space. The host CPU 110 does not directly access this BAR; rather, it simply exists to provide an addressable PCIe path from the physical SSDs to the IPU local memory 140. The MR switch 250 does not need to provide ID substitution (remapping) for any peer-to-peer transfers between the physical SSDs and the IPU local memory 140.

FIG. 2B provides a diagram illustrating an example of application data flows in the system architecture 200 according to one or more embodiments, with reference to components and features described herein including but not limited to the figures and associated description. When the host CPU 110 is running an application, the host CPU 110 can initiate data transfer requests for transferring application data between the host (e.g., between the host local memory 120 attached to the host CPU 110) and a VF/virtual SSD (as presented by the IPU 230 to the host CPU 110). For example, when the host CPU 110 requests a transfer of application data from the host local memory 120 to a virtual SSD, the IPU 230, operating in conjunction with the MR switch 250, causes the requested application data to be retrieved from the host local memory 120 and routed to a location in one of the physical SSDs (the target SSD) - e.g., as a direct memory access (DMA) data transfer, while bypassing temporary storage of the application data in the IPU local memory 140.

As an example, if the IPU 230 causes the application data to be transferred to a target SSD in the first storage tier 260, the flow of data follows a data path 225 between the host local memory 120 and the target SSD in the first storage tier 260. As another example, if the IPU 230 causes the application data to be transferred to a target SSD in the second storage tier 270, the flow of data follows a data path 227 between the host local memory 120 and the target SSD in the second storage tier 270. As explained in more detail with reference to FIGS. 3A-3B and 4A-4B herein, the direct data movement between host local memory 120 and the memory storage tiers is enabled by remapping a transaction identifier associated with the data transfer command such that the IOMMU 115 in the host CPU 110 “sees” a valid identifier associated with a virtual function.

FIG. 2C provides a diagram illustrating an example of data compaction and garbage collection flows in the system architecture 200 according to one or more embodiments, with reference to components and features described herein including but not limited to the figures and associated description. Data compaction (e.g., FTL compaction) involves transferring stored data between the first storage tier 260 (e.g., a “cache” tier) and the second storage tier 170 (e.g., a capacity” tier), and is conducted under the control of the IPU 230. For example, the IPU 230 can, as part of the FTL compaction process, cause reading and merging of valid data from the first storage tier 260 to the second storage tier 270 sequentially using, e.g., large-sized writes. For example, data stored in the first storage tier 260 may become “cold” (e.g., objects that have been reassigned from a hot tier to a cold tier) and, thus, is transferred to the second storage tier 270. To carry out this data transfer, the IPU 230 causes the subject stored data to be retrieved from an SSD in the first storage tier 260 and transferred directly to a target SSD in the second storage tier 270, with the data flow following the data path 265 (e.g., on a peer-peer basis). In embodiments this data transfer between SSDs is carried out in a peer-to-peer operation between the SSDs.

Similarly, as another example, data stored in the second storage tier 270 may, as a result of an application, become “hot” (e.g., objects that have been reassigned from a cold tier to a hot tier) and, thus, is transferred to the first storage tier 260. To carry out this data transfer, the IPU 230 causes the subject stored data to be retrieved from an SSD in the second storage tier 270 and transferred directly to a target SSD in the first storage tier 260, with the data flow following the data path 265 (e.g., on a peer-peer basis).

Garbage collection is conducted under the control of the IPU 230. As an example, to perform garbage collection on a target SSD in the second storage tier 270, the IPU 230 causes valid data in a used block on the target SSD to be copied to a new block on the target SSD, and the used block on the target SSD is erased, using (if available) on-SSD copy support. Thus the garbage collection causes data transfers that follow a local data path 267 within the target SSD. Alternatively, if on-SSD copy support is unavailable, the IPU 230 causes the valid data in a used block on the target SSD to be copied to a new block on the target SSD (or to a block in another SSD in the storage tier) using a peer-to-peer transfer via the MR switch 250, such that the data path 267 extends from the target SSD through the MR switch 250 and back.

By providing for direct data transfers between the host local memory 120 and a target SSD (over up to 16 PCIe lanes), the system architecture 200 eliminates the data bottleneck presented by the existing system architecture 100. For example, the IPU 230 is only involved in the NVMe command and response flows and for FTL metadata flows, while the transfer of application data bypasses the IPU 230 and temporary storage in the IPU local memory 140. Furthermore, the FTL compaction data flow can take place peer to peer through the MR switch 250 without involving the IPU local memory 140. Similarly, FTL garbage collection flow can take place within the target SSD using the on-SSD copy command or peer-to-peer transfer without involving the IPU local memory 140. Moreover, since the IPU 230 is not in the critical data path, it can use older generation PCIe (e.g., PCIe 4.0) at lower power and cost, even while the MR switch 250 and the SSDs in the first storage tier 260 and the second storage tier 270, being on the critical data path, use newer generation PCIe (e.g., PCIe 5.0).

Some or all components and/or features in the system architecture 200 can be implemented using one or more of a CPU, an IPU, a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, components of the system architecture 200 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the system architecture 200 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIGS. 3A-3B provide diagrams illustrating examples of command flow sequences for application data in a cloud-based system architecture according to one or more embodiments, with reference to components and features described herein including but not limited to the figures and associated description. The command flows as described herein operate between and among a host 302 (i.e., a host system), an IPU 304, an MR switch 306, and a target SSD 308, which in embodiments are arranged according to the system architecture 200 (as described and illustrated herein with reference to FIGS. 2A-2C). In embodiments the host 302 (host system) corresponds to the host CPU 110 with accompanying host local memory 120 (FIGS. 1A and 2A-2C, already discussed). In embodiments the IPU 304 corresponds to the IPU 230 (FIGS. 2A-2C, already discussed), and manages the target SSD 308. In embodiments the target SSD 308 corresponds to an SSD in the first storage tier 260 or in the second storage tier 270.

The MR switch 306 performs remapping (e.g., substitution and/or restoration of transaction IDs) as described herein. For example, MR switch 306 performs remapping of a transaction identifier field in a data transfer message (e.g., in a PCIe write request, a PCIe read request, or a PCIe data completion) between a first transaction identifier associated with the virtual function and a second transaction identifier associated with a physical storage device (e.g., the target SSD 308). In embodiments the MR switch 306 corresponds to the MR switch 250 with a remapping module (FIGS. 2A-2C, already discussed). In some embodiments the IPU 304 and the MR switch 306 are separate components; in some embodiments, some or all components or features of the MR switch 306 are integrated with the IPU 304 (or as part of the IPU subsystem). In embodiments, the operations performed by the MR switch 306 (including those operations pertaining to the remapping module as described herein) are performed in coordination with and/or under control of the IPU 304. Commands, requests, completions etc. are routed between and among the components of FIGS. 3A-3B (e.g., the host 302, the IPU 304, and the target SSD 308) via the MR switch 306 (e.g., as arranged in the system architecture 200 described and illustrated herein with reference to FIGS. 2A-2C).

The example command flow sequences described herein follow a typical three-phase process (e.g., in compliance with FTL/NVMe): a command phase, where the host issues a work order for the IPU (e.g., e.g., NVMe commands to read or write data); a data transfer phase, where data is transferred between the host local memory and storage using data transfer messages (e.g., a PCIe write request, or a PCIe read request followed by a PCIe data completion); and a completion phase, where the IPU issues a work order completion (e.g., NVMe command completion). Physical SSDs have a DMA engine to perform DMA data transfers to and from the SSD for transferring application data as described herein.

Turning to FIG. 3A, shown is an example of a command flow sequence 300 where the host 302 is to read application data — e.g., data coming to the host from another device. The host 302 interfaces with a VF provided by the IPU 304. As illustrated in FIG. 3A, a read process for transferring application data typically begins with the host 302 issuing, at label 312, an NVMe read command - e.g., to the VF provided by the IPU 304. The NVMe read command is provided by the IPU 304 to a target SSD 308 at label 314. The target SSD 308 is determined (e.g., identified) by the IPU 304. The MR switch 306 does not perform ID remapping at label 314 but, in some embodiments, performs retagging (e.g., substitution of a transaction tag). The target SSD 308 issues a PCIe write request (e.g., MWr) to perform the data transfer, based on (e.g., responsive to) the NVMe read command, at label 316. The PCIe write request includes the data to be transferred (e.g., via DMA transfer). In some cases, based on the total amount of data to be transferred and the amount of data that can be transferred with a single PCIe write request, the target SSD 308 will issue multiple PCIe write requests to perform the data transfer, where each PCIe write request is for the transfer of a portion of the total data transfer.

The PCIe write request issued at label 316 includes a transaction ID (e.g., as part of transaction ID field in a PCIe packet). The transaction ID includes a requester ID; in embodiments, the transaction ID also includes a transaction tag. When the target SSD 308 issues the PCIe write request, the PCIe write request has a requester ID that is associated with the target SSD 308. If this request (with the requester ID that is associated with the target SSD 308) happens to be routed to the host 302, the host 302 (e.g., via an IOMMU such as the IOMMU 115) will not recognize the requester ID and will therefore reject the data transfer request (e.g., the data transfer request will not be fulfilled).

The MR switch 306 intercepts the PCIe write request issued by the target SSD 308 and performs, via the remapping module, a substitution of the transaction identifier (ID) at label 318 — e.g., based on an applicable entry in a remapping table (such as the remapping table 450 described herein with reference to FIG. 4B). For example, the MR switch 306 substitutes a requester ID associated with a virtual function (e.g., for a virtual SSD as exposed by the IPU 304 to the host 302) for (in place of) the requester ID associated with the target SSD 308. The MR switch stores the requester ID associated with the target SSD 308 in the remapping table (e.g., in a record also including the requester ID associated with the VF). In embodiments, the MR switch 306 also performs retagging - i.e., substitutes a transaction tag associated with the virtual function for the transaction tag applied by the target SSD 308. In cases where the target SSD 308 issues multiple PCIe write requests to perform the data transfer, the MR switch 306 intercepts each of the PCIe write requests and performs transaction ID substitution for each.

Once the MR switch 306 performs the transaction ID substitution (e.g., substituting at least the requester ID and, in embodiments, the transaction tag), the PCIe write request(s) —now bearing the substituted transaction ID — is/are routed via the MR switch 306 to the host 302 at label 320. Because of the transaction ID substitution, the PCIe write request(s) will appear to the host 302 as if the requester is the virtual function (operated by the IPU 304) rather than the target SSD 308, such that the host 302 will permit the data transfer according to the received PCIe write request(s) — e.g., host 302 will cause the data accompanying the PCIe write request(s) to be stored in host memory.

At label 322 the target SSD 308 issues an NVMe command completion to the IPU 304. The IPU 304 issues an NVMe command completion to the host 302 at label 324. In some embodiments, the IPU 304 “sniffs” (e.g., detects) that the target SSD 308 has completed the data transfer phase and immediately posts a NVMe command completion to the host 302. The IPU 304 accomplishes this by, e.g., setting a filter on the writes originating from the SSD, which enables the IPU 304 to more quickly return the NVMe command completion to the host 302.

Turning now to FIG. 3B, shown is an example of a command flow sequence 350 where the host 302 is to write application data - e.g., data going from the host 302 to another device. The host 302 interfaces with a VF provided by the IPU 304. As illustrated in FIG. 3B, a write process for transferring application data typically begins with the host 302 issuing, at label 352, an NVMe write command - e.g., to the VF provided by the IPU 304. The NVMe write command is provided by the IPU 304 to a target SSD 308 at label 354. The target SSD 308 is determined (e.g., identified) by the IPU 304. The MR switch 306 does not perform ID remapping at label 354 but, in some embodiments, performs retagging (e.g., substitution of a transaction tag). The target SSD 308 issues a PCIe read request (e.g., MRd) to perform the data transfer, based on (e.g., responsive to) the NVMe write command, at label 356. In some cases, based on the total amount of data to be transferred and the amount of data that can be requested with a single PCIe read request, the target SSD 308 will issue multiple PCIe read requests to perform the data transfer, where each PCIe read request is for a portion of the total data transfer.

The PCIe read request issued at label 356 includes a transaction ID (e.g., as part of a transaction ID field in a PCIe packet). The transaction ID includes a requester ID; in embodiments, the transaction ID also includes a transaction tag. When the target SSD 308 issues the PCIe read request, the PCIe read request has a requester ID that is associated with the target SSD 308. If this request (with the requester ID that is associated with the target SSD 308) happens to be routed to the host 302, the host 302 (e.g., via an IOMMU such as the IOMMU 115) will not recognize the requester ID and will therefore reject the data transfer request (e.g., the data transfer request will not be fulfilled).

The MR switch 306 intercepts the PCIe read request issued by the target SSD 308 and performs, via the remapping module, a substitution of the transaction identifier (ID) at label 358 — e.g., based on an applicable entry in a remapping table (such as the remapping table 450 described herein with reference to FIG. 4B). For example, the MR switch 306 substitutes a requester ID associated with a virtual function (e.g., a virtual SSD as exposed by the IPU 304 to the host 302) for (in place of) the requester ID associated with the target SSD 308. The MR switch stores the requester ID associated with the target SSD 308 in the remapping table (e.g., in a record also including the requester ID associated with the VF). In embodiments, the MR switch 306 also performs retagging - i.e., substitutes a transaction tag associated with the virtual function for the transaction tag applied by the target SSD 308. In cases where the target SSD 308 issues multiple PCIe read requests to perform the data transfer, the MR switch 306 intercepts each of the PCIe read requests and performs transaction ID substitution for each.

Once the MR switch 306 performs the transaction ID substitution (e.g., substituting at least the requester ID and, in embodiments, the transaction tag), the PCIe read request(s) —now bearing the substituted transaction ID — is/are routed via the MR switch 306 to the host 302 at label 360. Because of the transaction ID substitution, the PCIe write request(s) will appear to the host 302 as if the requester is the virtual function (operated by the IPU 304) rather than the target SSD 308, such that the host 302 will permit the data transfer according to the received PCIe write request(s) — e.g., host 302 will cause the data requested by the PCIe read request(s) to be read from host memory and sent to the requester.

At label 362, the host 302 issues a PCIe data completion (e.g., Cp1D) responsive to the received PCIe read request. The PCIe data completion includes the data to be transferred (e.g., via DMA transfer). In some cases, based on the total amount of data to be transferred and the amount of data that can be transferred with a single PCIe data completion, the host 302 will issue multiple PCIe data completions to perform the data transfer, where each PCIe data completion is for the transfer of a portion of the total data transfer. The PCIe data completion issued at label 362 includes a transaction ID (e.g., as part of a transaction ID field in a PCIe packet). The transaction ID includes a requester ID (may also be known as a completer ID for PCIe data completions); in embodiments, the transaction ID also includes a transaction tag.

The MR switch 306 intercepts the PCIe data completion issued by the host 302 and performs, via the remapping module, a transaction ID substitution at label 364 — e.g., an “inverse” substitution restoring the transaction ID for the target SSD 308 based on an applicable entry in a remapping table (such as the remapping table 450 described herein with reference to FIG. 4B). For example, the MR switch 306 substitutes the requester ID associated with the target SSD 308 for (in place of) the requester ID (e.g., completer ID) associated with the VF exposed to the host 302. In embodiments, the MR switch 306 also performs retagging - i.e., substitutes the transaction tag applied by the target SSD 308 for a transaction tag associated with the virtual function. In this manner, the MR switch 306 restores the transaction ID that had been provided by the target SSD 308 with the PCIe read request at label 356. In cases where the host 302 issues multiple PCIe data completions to perform the data transfer, the MR switch 306 intercepts each of the PCIe data completions and performs transaction ID substitution for each.

Once the MR switch 306 performs the transaction ID substitution at label 364 (e.g., restoring at least the requester ID and, in embodiments, the transaction tag), the PCIe data completions(s) — now bearing the transaction ID for the target SSD 308 - is/are routed via the MR switch 306 to the target SSD 308 at label 366, and the target SSD 308 then stores the data sent with the PCIe data completion(s). At label 368 the target SSD 308 issues an NVMe command completion to the IPU 304. The IPU 304 issues an NVMe command completion to the host 302 at label 370.

FIG. 4A provides a diagram illustrating an example of a multi-root (MR) switch 400 according to one or more embodiments, with reference to components and features described herein including but not limited to the figures and associated description. In embodiments, the MR switch 400 corresponds to the MR switch 250 (FIGS. 2A-2C, already discussed) and/or the MR switch 306 (FIGS. 3A-3B, already discussed). The MR switch 400 includes a remapping module 420 to perform the remapping features described herein with reference to FIGS. 2A-2C, 3, and 4B. The remapping module 420 includes logic 422 and memory 424. In embodiments the logic 422 includes configurable logic, or fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits. The memory 424 can include any suitable memory for storing data such as, e.g., DRAM, static RAM (SRAM), etc. In embodiments the memory 424 stores a remapping table (described herein with reference to FIG. 4B).

The MR switch 400 is coupled to an IPU 430 via, e.g., PCIe lanes. In embodiments, the IPU 430 corresponds to the IPU 230 (FIGS. 2A-2C, already discussed) and/or the IPU 304 (FIGS. 3A-3B, already discussed). For example, the MR switch 400 and the IPU 430 are arranged according to the system architecture 200 (as described and illustrated herein with reference to FIGS. 2A-2C), such that the MR switch 400 is coupled to the IPU 430 via 16 PCIe lanes. In some embodiments, the MR switch 400 and the IPU 430 are separate components; in some embodiments, some or all components or features of the MR switch 400 are integrated with the IPU 430 (or as part of the IPU subsystem). In embodiments, the operations performed by the MR switch 400 (including those operations pertaining to the remapping module as described herein) are performed in coordination with and/or under control of the IPU 430.

FIG. 4B illustrates an example of a remapping table 450 according to one or more embodiments, with reference to components and features described herein including but not limited to the figures and associated description. In embodiments the remapping table 450 is stored in the memory 424 of the remapping module 420 in the MR switch 400 (FIG. 4A, already discussed). As illustrated in FIG. 4B, the remapping table 450 includes a series of entries corresponding to various data transactions 452 (e.g., data transfers) to be carried out by a cloud-based system having an architecture such as the system architecture 200 (FIGS. 2A-2C, already discussed). Entries in the remapping table 450 include requester IDs 454 associated with one or more target SSD(s) (e.g., the target SSD 308 in FIGS. 3A-3B), transaction tags 456 for various transactions being performed by the target SSD(s), remapped requester IDs 458 (e.g., requester IDs associated with virtual functions exposed to the host by the IPU), and remapped transaction tags 460 (e.g., tags associated with various transactions being performed by the virtual functions).

In the example illustrated in FIG. 4B, the remapping table 450 has entries for N data transactions 452 that include individual transactions Tr1, Tr2, Tr3, Tr4, ... TrN. Corresponding entries for the N transactions include target SSD requester IDs 454 (R1 and R2) and transaction tags 456 (T1, T2, T3, T4, ... TN), and remapped requester IDs 458 (Q2 and Q4) and transaction tags 460 (G1, G2, G3, G4, ... GN). It should be noted that any given target SSD (e.g., R1 or R2) or virtual SSD (e.g., Q2 or Q4) can be involved with multiple transactions. In some embodiments, if transaction tag remapping is not performed the remapping table 450 does need to include the transaction tags (e.g., in such embodiments the transaction tags are optional in the remapping table 450). In some embodiments the tag numbering and/or the remapped tag numbering can start over (e.g., for transaction Tr4 the tag number can restart at T1 and/or the remapped tag number can restart at G1).

As one example, for a first transaction Tr1 (label 462) the remapping table includes a target SSD requester ID R1, a target SSD tag T1, a remapped requester ID Q2, and a remapped tag G1. The entries R1, T1, Q2 and G1 can be part of the same record for the transaction Tr1. For a data transfer message (e.g., read request or write request) provided by the target SSD relating to the transaction Tr1, the MR switch 400 will perform a transaction ID substitution, by substituting the remapped requester ID Q2 (associated with a virtual SSD) in place of the requester ID R1 (associated with a target SSD), before the data transfer command is provided to the host. In embodiments where transaction tag remapping occurs, the MR switch 400 will also substitute the transaction tag G1 for the transaction tag T1. For a data completion the MR switch 400 will perform a transaction ID substitution (e.g., an “inverse” substitution restoring the transaction ID) by substituting the requester ID R1 (associated with the target SSD) in place of the remapped requester ID Q2 (associated with the virtual SSD). In embodiments where the transaction tag was remapped, the MR switch 400 will also substitute the transaction tag T1 for the transaction tag G1.

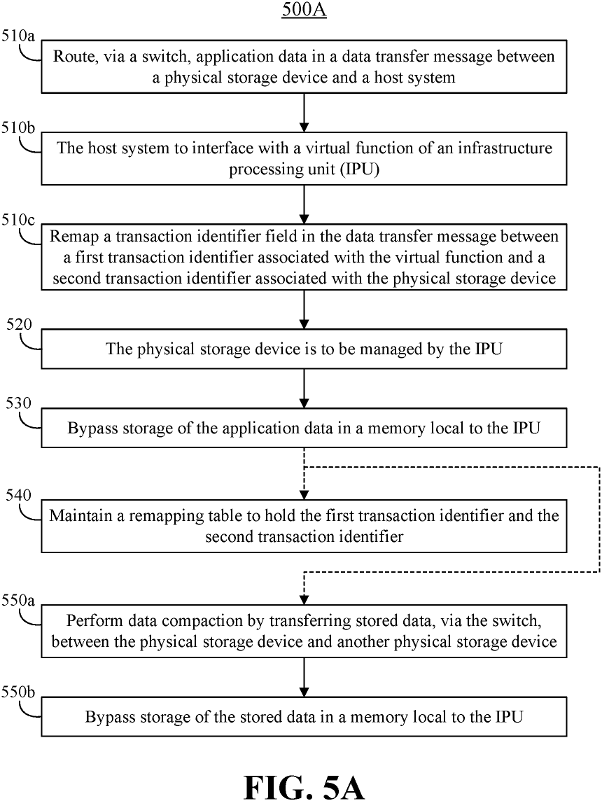

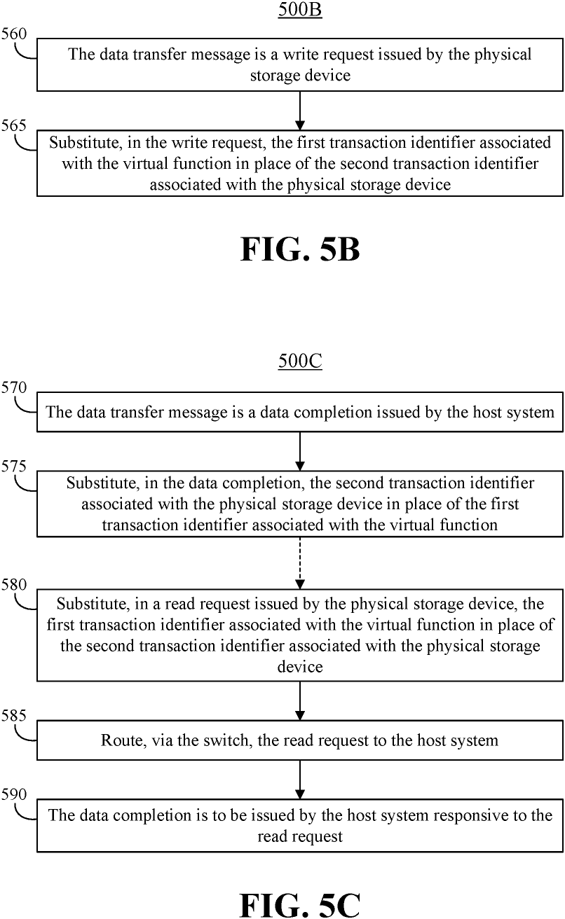

FIGS. 5A-5C provide flow diagrams illustrating an example application data transfer method 500 (including process components 500A, 500B, and 500C) according to one or more embodiments, with reference to components and features described herein including but not limited to the figures and associated description. The method 500 can generally be implemented in the system architecture 200 (FIGS. 2A-2C, already discussed) and/or via components or features of the MR switch 250 (FIGS. 2A-2C, already discussed), the MR switch 306 (FIGS. 3A-3B, already discussed) and/ or the MR switch 400 (FIGS. 4A-4B, already discussed), and/or in conjunction or coordination with the IPU 230 (FIGS. 2A-2C, already discussed), the IPU 304 (FIGS. 3A-3B, already discussed) and/or the IPU 430 (FIG. 4A, already discussed). In embodiments the method 500 performs operations to carry out the command flow sequence 300 and/or the command flow sequence 350, and/or portions thereof.

More particularly, the method 500 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the method 500 and/or functions associated therewith can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Turning to FIG. 5A, the method 500A begins at illustrated processing block 510a by routing, via a switch, application data in a data transfer message between a physical storage device and a host system, where at block 510b the host system interfaces with a virtual function of an infrastructure processing unit (IPU). The data transfer message can be, e.g., a write request (e.g. a PCIe write request) or a data completion (e.g. a PCIe data completion). Routing application data includes, at illustrated processing block 510c, remapping a transaction identifier field in the data transfer message between a first transaction identifier associated with the virtual function and a second transaction identifier associated with the physical storage device. Block 520 provides that the physical storage device is managed by the IPU. Illustrated processing block 530 provides that routing the application data between the host system and the physical storage device bypasses temporary storage of the application data in a memory local to the IPU.

In some embodiments, illustrated processing block 540 provides for maintaining a remapping table to hold the first transaction identifier and the second transaction identifier. The remapping table can correspond to the remapping table 450 (FIG. 4B, already discussed). In some embodiments, the first transaction identifier includes a virtual requester identifier associated with the virtual function, and the second transaction identifier includes a requester identifier for the physical storage device. In some embodiments, the first transaction identifier further includes a first tag, and the second transaction identifier further includes a second tag. In some embodiments, the transaction identifier field includes a requester identifier field. In some embodiments, the transaction identifier field further includes a tag field.

In some embodiments, illustrated processing block 550a provides for performing data compaction by transferring stored data, via the switch, between the physical storage device and another physical storage device while, at block 550b, bypassing temporary storage of the stored data in the memory local to the IPU.

Turning now to FIG. 5B, in some embodiments the method 500B provides, at illustrated processing block 560, that the data transfer message is a write request (e.g., a PCIe write request) issued by the physical storage device, where remapping the transaction identifier in the data transfer message (block 510c) includes, at illustrated processing block 565, substituting, in the write request, the first transaction identifier associated with the virtual function in place of the second transaction identifier associated with the physical storage device.

Turning now to FIG. 5C, in some embodiments the method 500C provides, at illustrated processing block 570, that the data transfer message is a data completion (e.g., a PCIe data completion) issued by the host system, where remapping the transaction identifier in the data transfer message (block 510c) includes, at illustrated processing block 575, substituting, in the data completion, the second transaction identifier associated with the physical storage device in place of the first transaction identifier associated with the virtual function. In some embodiments, illustrated processing block 580 provides for substituting, in a read request (e.g., a PCIe read request) issued by the physical storage device, the first transaction identifier associated with the virtual function in place of the second transaction identifier associated with the physical storage device, and illustrated processing block 585 provides for routing, via the switch, the read request to the host system, where at block 590 the data completion is issued by the host system responsive to the read request.

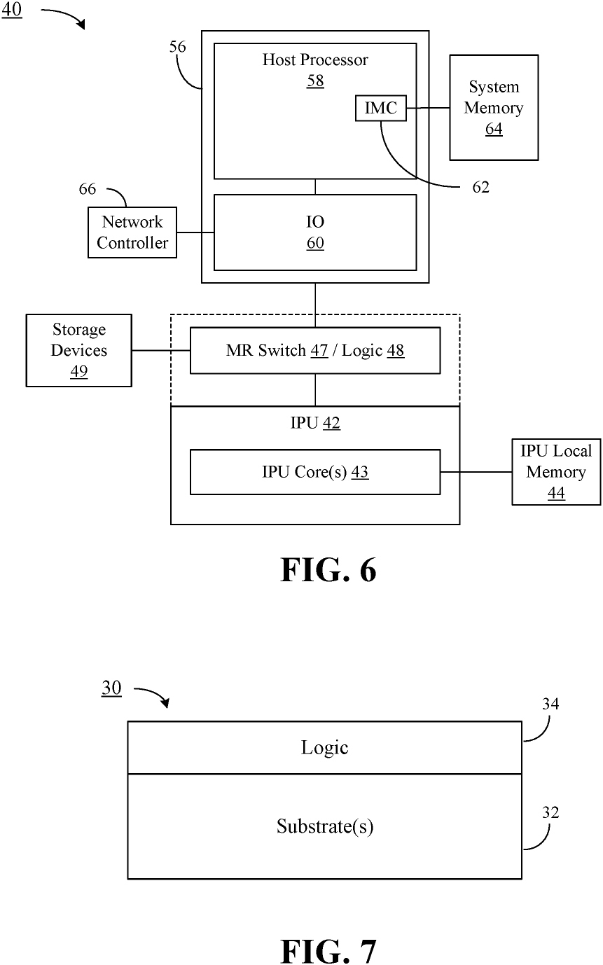

FIG. 6 is a block diagram of an example of a performance-enhanced computing system 40 according to one or more embodiments, with reference to components and features described herein including but not limited to the figures and associated description. The system 40 can be part of a server (e.g., a cloud server), desktop computer, notebook computer, tablet computer, convertible tablet, smart television (TV), personal digital assistant (PDA), mobile Internet device (MID), smart phone, wearable device, media player, vehicle, robot, Internet of Things (IoT) device, drone, autonomous vehicle, etc., or any combination thereof. In the illustrated example, an input/output (IO) module 60 is communicatively coupled to a network controller 66 (e.g., wired, wireless).

In embodiments, the system 40 includes a host processor 58 (e.g., central processing unit/CPU) that includes an integrated memory controller (IMC) 62, wherein the illustrated IMC 62 communicates with a system memory 64 (e.g., DRAM) over a bus or other suitable communication interface. In embodiments the host processor 58 and the IO module 60 are integrated onto a shared semiconductor die 56 in a system on chip (SoC) architecture. In embodiments, the host processor 58 corresponds to the host CPU 110 (FIGS. 1A and 2A) and/or the host 302 (FIGS. 3A-3B), and/or portions thereof.

In embodiments, the IPU 42 includes IPU core(s) 43 which are processing cores. In some embodiments the IPU 42 is implemented using an FPGA (e.g., an FPGA platform). The IPU communicates with IPU local memory 44 (e.g., DRAM) over a bus or other suitable communication interface. In embodiments, the IPU 42 corresponds to the IPU 230 (FIGS. 2A-2C), the IPU 304 (FIGS. 3A-3B) and/or the IPU 430 (FIG. 4A).

The switch 47 is coupled to the host processor 58, the IPU 42, and to storage devices 49. In embodiments, the switch 47 includes logic 48 to implement features such as, e.g., a remapping module (e.g., the remapping module 420 in FIG. 4A). In embodiments, the logic 48 can implement one or more aspects of the processes described above, including the method 500 (FIGS. 5A-5C). In embodiments, the switch 47 corresponds to the MR switch 250 (FIGS. 2A-2C), the MR switch 306 (FIGS. 3A-3B) and/or the MR switch 400 (FIGS. 4A-4B). The storage devices include a plurality of SSDs. In embodiments, the storage devices 49 correspond to SSDs in the first storage tier 260 and/or SSDs in the second storage tier 270.

The computing system 40 is therefore performance-enhanced at least to the extent that it provides for transaction identifier remapping to enable direct application data transfers between host memory and storage drives in a cloud-based architecture having an IPU, while bypassing temporary storage of the application data in local IPU memory.

FIG. 7 is a block diagram illustrating an example semiconductor apparatus 30 according to one or more embodiments, with reference to components and features described herein including but not limited to the figures and associated description. The semiconductor apparatus 30 can be implemented, e.g., as a chip, die, or other semiconductor package. The semiconductor apparatus 30 can include one or more substrates 32 comprised of, e.g., silicon, sapphire, gallium arsenide, etc. The semiconductor apparatus 30 can also include logic 34 comprised of, e.g., transistor array(s) and other integrated circuit (IC) components) coupled to the substrate(s) 32. The logic 34 can be implemented at least partly in configurable logic or fixed-functionality logic hardware. The logic 34 can implement the system on chip (SoC) 56, the IPU 42 and/or the switch 47 (or components thereof) described above with reference to FIG. 6. The logic 34 can implement one or more aspects of the processes described above, including the method 500 (FIGS. 5A-5C). The logic 34 can implement one or more aspects of the system architecture 200 (FIGS. 2A-2C). The apparatus 30 is therefore considered to be performance-enhanced at least to the extent that it provides for transaction identifier remapping to enable direct application data transfers between host memory and storage drives in a cloud-based architecture having an IPU, while bypassing temporary storage of the application data in local IPU memory.

The semiconductor apparatus 30 can be constructed using any appropriate semiconductor manufacturing processes or techniques. For example, the logic 34 can include transistor channel regions that are positioned (e.g., embedded) within the substrate(s) 32. Thus, the interface between the logic 34 and the substrate(s) 32 may not be an abrupt junction. The logic 34 can also be considered to include an epitaxial layer that is grown on an initial wafer of the substrate(s) 32.

Embodiments of each of the above systems, devices, components, features and/or methods, including the system architecture 200, the IPU 230, the MR switch 250, the command flow sequence 300, the IPU 304, the MR switch 306, the MR switch 400, the remapping module 420, the IPU 430, the method 500, and/or any other system components, can be implemented in hardware, software, or any suitable combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

Alternatively, or additionally, all or portions of the foregoing systems, devices, components, features and/or methods can be implemented in one or more modules as a set of program or logic instructions stored in a machine- or computer-readable storage medium such as RAM, ROM, PROM, firmware, flash memory, etc., to be executed by a processor or computing device. For example, computer program code to carry out the operations of the components can be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages.

### Additional Notes and Examples

Example A1 includes a semiconductor apparatus comprising one or more substrates, and logic coupled to the one or more substrates, wherein the logic is implemented at least partly in one or more of configurable logic or fixed-functionality hardware logic, the logic to route, via a switch, application data in a data transfer message between a physical storage device and a host system, the host system to interface with a virtual function of an infrastructure processing unit (IPU), by remapping a transaction identifier field in the data transfer message between a first transaction identifier associated with the virtual function and a second transaction identifier associated with the physical storage device, wherein the physical storage device is to be managed by the IPU, and wherein to route the application data between the host system and the physical storage device includes to bypass temporary storage of the application data in a memory local to the IPU.

Example A2 includes the apparatus of Example A1, wherein the data transfer message is a write request issued by the physical storage device, and wherein to perform remapping the transaction identifier field in the data transfer message the logic is to: substitute, in the write request, the first transaction identifier associated with the virtual function in place of the second transaction identifier associated with the physical storage device.

Example A3 includes the apparatus of Example A1 or A2, wherein the data transfer message is a data completion issued by the host system, and wherein to perform remapping the transaction identifier field in the data transfer message the logic is to substitute, in the data completion, the second transaction identifier associated with the physical storage device in place of the first transaction identifier associated with the virtual function.

Example A4 includes the apparatus of Example A1, A2 or A3, wherein the logic is to substitute, in a read request to be issued by the physical storage device, the first transaction identifier associated with the virtual function in place of the second transaction identifier associated with the physical storage device, and route, via the switch, the read request to the host system, wherein the data completion is to be issued by the host system responsive to the read request.

Example A5 includes the apparatus of any of Examples A1-A4, wherein the logic is to maintain a remapping table to hold the first transaction identifier and the second transaction identifier.

Example A6 includes the apparatus of any of Examples A1-A5, wherein the first transaction identifier includes a virtual requester identifier associated with the virtual function, wherein the second transaction identifier includes a requester identifier for the physical storage device, and wherein the transaction identifier field includes a requester identifier field.

Example A7 includes the apparatus of any of Examples A1-A6, wherein the first transaction identifier further includes a first tag, wherein the second transaction identifier further includes a second tag, and wherein the transaction identifier field further includes a tag field.

Example A8 includes the apparatus of any of Examples A1-A7, wherein the logic is to perform data compaction by transferring stored data, via the switch, between the physical storage device and another physical storage device while bypassing temporary storage of the stored data in the memory local to the IPU.

Example A9 includes the apparatus of any of Examples A1-A8, wherein the physical SSD is hidden from the host system.

Example S1 includes a computing system comprising a host system comprising a host processor coupled to a host memory, an infrastructure processing unit (IPU), a plurality of storage devices, and a multi-root (MR) switch coupled to the host system, the IPU and the plurality of storage devices, wherein the computing system includes logic implemented at least partly in one or more of configurable logic or fixed-functionality hardware logic, the logic to route, via the MR switch, application data in a data transfer message between one of the physical storage devices and the host system, the host system to interface with a virtual function of the IPU, by remapping a transaction identifier field in the data transfer message between a first transaction identifier associated with the virtual function and a second transaction identifier associated with the one of the physical storage devices, wherein the physical storage devices are to be managed by the IPU, and wherein to route the application data between the host system and the one of the physical storage devices includes to bypass temporary storage of the application data in a memory local to the IPU.

Example S2 includes the computing system of Example S1, wherein the data transfer message is a write request issued by the physical storage device, and wherein to perform remapping the transaction identifier field in the data transfer message the logic is to substitute, in the write request, the first transaction identifier associated with the virtual function in place of the second transaction identifier associated with the physical storage device.

Example S3 includes the computing system of Example S1 or S2, wherein the data transfer message is a data completion issued by the host system, and wherein to perform remapping the transaction identifier field in the data transfer message the logic is to substitute, in the data completion, the second transaction identifier associated with the physical storage device in place of the first transaction identifier associated with the virtual function.

Example S4 includes the computing system of Example S1, S2 or S3, wherein the logic is to substitute, in a read request to be issued by the physical storage device, the first transaction identifier associated with the virtual function in place of the second transaction identifier associated with the physical storage device, and route, via the switch, the read request to the host system, wherein the data completion is to be issued by the host system responsive to the read request.

Example S5 includes the computing system of any of Examples S1-S4, wherein the logic is to maintain a remapping table to hold the first transaction identifier and the second transaction identifier.

Example S6 includes the computing system of any of Examples S1-S5, wherein the first transaction identifier includes a virtual requester identifier associated with the virtual function, wherein the second transaction identifier includes a requester identifier for the physical storage device, and wherein the transaction identifier field includes a requester identifier field.

Example S7 includes the computing system of any of Examples S1-S6, wherein the first transaction identifier further includes a first tag, wherein the second transaction identifier further includes a second tag, and wherein the transaction identifier field further includes a tag field.

Example S8 includes the computing system of any of Examples S1-S7, wherein the logic is to perform data compaction by transferring stored data, via the switch, between the physical storage device and another physical storage device while bypassing temporary storage of the stored data in the memory local to the IPU.

Example S9 includes the computing system of any of Examples S1-S8, wherein the physical SSD is hidden from the host system.

Example C1 includes at least one computer readable storage medium comprising a set of instructions which, when executed by a computing device, cause the computing device to route, via a switch, application data in a data transfer message between a physical storage device and a host system, the host system to interface with a virtual function of an infrastructure processing unit (IPU), by remapping a transaction identifier field in the data transfer message between a first transaction identifier associated with the virtual function and a second transaction identifier associated with the physical storage device, wherein the physical storage device is to be managed by the IPU, and wherein to route the application data between the host system and the physical storage device includes to bypass temporary storage of the application data in a memory local to the IPU.

Example C2 includes the at least one computer readable storage medium of Example C1, wherein the data transfer message is a write request issued by the physical storage device, and wherein to perform remapping the transaction identifier field in the data transfer message the instructions, when executed, cause the computing device to substitute, in the write request, the first transaction identifier associated with the virtual function in place of the second transaction identifier associated with the physical storage device.

Example C3 includes the at least one computer readable storage medium of Example C1 or C2, wherein the data transfer message is a data completion issued by the host system, and wherein to perform remapping the transaction identifier field in the data transfer message the instructions, when executed, cause the computing device to substitute, in the data completion, the second transaction identifier associated with the physical storage device in place of the first transaction identifier associated with the virtual function.

Example C4 includes the at least one computer readable storage medium of Example C1, C2 or C3, wherein the instructions, when executed, cause the computing device to substitute, in a read request to be issued by the physical storage device, the first transaction identifier associated with the virtual function in place of the second transaction identifier associated with the physical storage device, and route, via the switch, the read request to the host system, wherein the data completion is to be issued by the host system responsive to the read request.

Example C5 includes the at least one computer readable storage medium of any of Examples C1-C4, wherein the instructions, when executed, cause the computing device to maintain a remapping table to hold the first transaction identifier and the second transaction identifier.

Example C6 includes the at least one computer readable storage medium of any of Examples C1-C5, wherein the first transaction identifier includes a virtual requester identifier associated with the virtual function, wherein the second transaction identifier includes a requester identifier for the physical storage device, and wherein the transaction identifier field includes a requester identifier field.

Example C7 includes the at least one computer readable storage medium of any of Examples C1-C6, wherein the first transaction identifier further includes a first tag, wherein the second transaction identifier further includes a second tag, and wherein the transaction identifier field further includes a tag field.

Example C8 includes the at least one computer readable storage medium of any of Examples C1-C7, wherein the instructions, when executed, cause the computing device to perform data compaction by transferring stored data, via the switch, between the physical storage device and another physical storage device while bypassing temporary storage of the stored data in the memory local to the IPU.

Example C9 includes the at least one computer readable storage medium of any of Examples C1-C8, wherein the physical SSD is hidden from the host system.

Example M1 includes a method comprising routing, via a switch, application data in a data transfer message between a physical storage device and a host system, the host system interfacing with a virtual function of an infrastructure processing unit (IPU), by remapping a transaction identifier field in the data transfer message between a first transaction identifier associated with the virtual function and a second transaction identifier associated with the physical storage device, wherein the physical storage device is managed by the IPU, and wherein routing the application data between the host system and the physical storage device includes bypassing temporary storage of the application data in a memory local to the IPU.

Example M2 includes the method of Example M1, wherein the data transfer message is a write request issued by the physical storage device, and wherein remapping the transaction identifier in the data transfer message comprises substituting, in the write request, the first transaction identifier associated with the virtual function in place of the second transaction identifier associated with the physical storage device.

Example M3 includes the method of Example M1 or M2, wherein the data transfer message is a data completion issued by the host system, and wherein remapping the transaction identifier in the data transfer message comprises substituting, in the data completion, the second transaction identifier associated with the physical storage device in place of the first transaction identifier associated with the virtual function.

Example M4 includes the method of Example M1, M2 or M3, further comprising substituting, in a read request issued by the physical storage device, the first transaction identifier associated with the virtual function in place of the second transaction identifier associated with the physical storage device, and routing, via the switch, the read request to the host system, wherein the data completion is issued by the host system responsive to the read request.

Example M5 includes the method of any of Examples M1-M4, further comprising maintaining a remapping table to hold the first transaction identifier and the second transaction identifier.

Example M6 includes the method of any of Examples M1-M5, wherein the first transaction identifier includes a virtual requester identifier associated with the virtual function, wherein the second transaction identifier includes a requester identifier for the physical storage device, and wherein the transaction identifier field includes a requester identifier field.

Example M7 includes the method of any of Examples M1-M6, wherein the first transaction identifier further includes a first tag, wherein the second transaction identifier further includes a second tag, and wherein the transaction identifier field further includes a tag field.

Example M8 includes the method of any of Examples M1-M7, further comprising performing data compaction by transferring stored data, via the switch, between the physical storage device and another physical storage device while bypassing temporary storage of the stored data in the memory local to the IPU.

Example M9 includes the method of any of Examples M1-M8, wherein the physical SSD is hidden from the host system.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A semiconductor apparatus comprising:
one or more substrates; and
logic coupled to the one or more substrates, wherein the logic is implemented at least partly in one or more of configurable logic or fixed-functionality hardware logic, the logic to:
route, via a switch, application data in a data transfer message between a physical storage device and a host system, the host system to interface with a virtual function of an infrastructure processing unit (IPU), by remapping a transaction identifier field in the data transfer message between a first transaction identifier associated with the virtual function and a second transaction identifier associated with the physical storage device;
wherein the physical storage device is to be managed by the IPU, and
wherein to route the application data between the host system and the physical storage device includes to bypass temporary storage of the application data in a memory local to the IPU.

2. The apparatus of claim 1, wherein the data transfer message is a write request issued by the physical storage device, and wherein to perform remapping the transaction identifier field in the data transfer message the logic is to:
substitute, in the write request, the first transaction identifier associated with the virtual function in place of the second transaction identifier associated with the physical storage device.

3. The apparatus of claim 1, wherein the data transfer message is a data completion issued by the host system, and wherein to perform remapping the transaction identifier field in the data transfer message the logic is to:
substitute, in the data completion, the second transaction identifier associated with the physical storage device in place of the first transaction identifier associated with the virtual function.

4. The apparatus of claim 3, wherein the logic is to:
substitute, in a read request to be issued by the physical storage device, the first transaction identifier associated with the virtual function in place of the second transaction identifier associated with the physical storage device; and
route, via the switch, the read request to the host system;
wherein the data completion is to be issued by the host system responsive to the read request.

5. The apparatus of claim 1, wherein the logic is to maintain a remapping table to hold the first transaction identifier and the second transaction identifier.

6. The apparatus of claim 1, wherein the first transaction identifier includes a virtual requester identifier associated with the virtual function, wherein the second transaction identifier includes a requester identifier for the physical storage device, and wherein the transaction identifier field includes a requester identifier field.

7. The apparatus of claim 6, wherein the first transaction identifier further includes a first tag, wherein the second transaction identifier further includes a second tag, and wherein the transaction identifier field further includes a tag field.

8. The apparatus of claim 1, wherein the logic is to perform data compaction by transferring stored data, via the switch, between the physical storage device and another physical storage device while bypassing temporary storage of the stored data in the memory local to the IPU.

9. A computing system comprising:
a host system comprising a host processor coupled to a host memory;
an infrastructure processing unit (IPU);
a plurality of storage devices; and
a multi-root (MR) switch coupled to the host system, the IPU and the plurality of storage devices,
wherein the computing system includes logic implemented at least partly in one or more of configurable logic or fixed-functionality hardware logic, the logic to:
route, via the MR switch, application data in a data transfer message between one of the physical storage devices and the host system, the host system to interface with a virtual function of the IPU, by remapping a transaction identifier field in the data transfer message between a first transaction identifier associated with the virtual function and a second transaction identifier associated with the one of the physical storage devices;
wherein the physical storage devices are to be managed by the IPU, and
wherein to route the application data between the host system and the one of the physical storage devices includes to bypass temporary storage of the application data in a memory local to the IPU.

10. The computing system of claim 9, wherein the data transfer message is a write request issued by the physical storage device, and wherein to perform remapping the transaction identifier field in the data transfer message the logic is to:
substitute, in the write request, the first transaction identifier associated with the virtual function in place of the second transaction identifier associated with the physical storage device.

11. The computing system of claim 9, wherein the data transfer message is a data completion issued by the host system, wherein to perform remapping the transaction identifier field in the data transfer message the logic is to substitute, in the data completion, the second transaction identifier associated with the physical storage device in place of the first transaction identifier associated with the virtual function;
and wherein the logic is further to:
substitute, in a read request to be issued by the physical storage device, the first transaction identifier associated with the virtual function in place of the second transaction identifier associated with the physical storage device; and
route, via the switch, the read request to the host system;
wherein the data completion is to be issued by the host system responsive to the read request.

12. The computing system of claim 9, wherein the logic is to maintain a remapping table to hold the first transaction identifier and the second transaction identifier.

13. The computing system of claim 9, wherein the first transaction identifier includes a virtual requester identifier associated with the virtual function and a first tag, wherein the second transaction identifier includes a requester identifier for the physical storage device and a second tag, and wherein the transaction identifier field includes a requester identifier field and a tag field.

14. The computing system of claim 9, wherein the logic is to perform data compaction by transferring stored data, via the switch, between the physical storage device and another physical storage device while bypassing temporary storage of the stored data in the memory local to the IPU.

15. At least one computer readable storage medium comprising a set of instructions which, when executed by a computing device, cause the computing device to:
route, via a switch, application data in a data transfer message between a physical storage device and a host system, the host system to interface with a virtual function of an infrastructure processing unit (IPU), by remapping a transaction identifier field in the data transfer message between a first transaction identifier associated with the virtual function and a second transaction identifier associated with the physical storage device;
wherein the physical storage device is to be managed by the IPU, and
wherein to route the application data between the host system and the physical storage device includes to bypass temporary storage of the application data in a memory local to the IPU.

16. The at least one computer readable storage medium of claim 15, wherein the data transfer message is a write request issued by the physical storage device, and wherein to perform remapping the transaction identifier field in the data transfer message the instructions, when executed, cause the computing device to:
substitute, in the write request, the first transaction identifier associated with the virtual function in place of the second transaction identifier associated with the physical storage device.

17. The at least one computer readable storage medium of claim 15, wherein the data transfer message is a data completion issued by the host system, wherein to perform remapping the transaction identifier field in the data transfer message the instructions, when executed, cause the computing device to substitute, in the data completion, the second transaction identifier associated with the physical storage device in place of the first transaction identifier associated with the virtual function;
and wherein the instructions, when executed, further cause the computing device to:
substitute, in a read request to be issued by the physical storage device, the first transaction identifier associated with the virtual function in place of the second transaction identifier associated with the physical storage device; and
route, via the switch, the read request to the host system;
wherein the data completion is to be issued by the host system responsive to the read request.

18. The at least one computer readable storage medium of claim 15, wherein the instructions, when executed, cause the computing device to maintain a remapping table to hold the first transaction identifier and the second transaction identifier.

19. The at least one computer readable storage medium of claim 15, wherein the first transaction identifier includes a virtual requester identifier associated with the virtual function and a first tag, wherein the second transaction identifier includes a requester identifier for the physical storage device and a second tag, and wherein the transaction identifier field includes a requester identifier field and a tag field.

20. The at least one computer readable storage medium of claim 15, wherein the instructions, when executed, cause the computing device to perform data compaction by transferring stored data, via the switch, between the physical storage device and another physical storage device while bypassing temporary storage of the stored data in the memory local to the IPU.
